(19) United States
(12) Patent Application Publication
(10) Pub. No.: US 2008/0276505 A1
(43) Pub. Date: Nov. 13, 2008

(54) Backlit faceplate for data appliances and related methods

(76) Inventors: Foster Hinshaw, Somerville, MA (US); John Chiu, Lexington, MA (US)

Correspondence Address: GOODWIN PROCTER LLP;PATENT ADMINISTRATOR, EXCHANGE PLACE, BOSTON, MA, 02109-2881, US

(21) Appl. No.: 11/801,573

(22) Filed: May 9, 2007

(51) Int. Cl. G09F 13/00

(52) U.S. Cl. 40/541

(57) ABSTRACT

A display for a data-appliance cabinet comprises a panel having front and rear surfaces and dimensions matching a front-side portion of a data-appliance cabinet allocated to an absent accessory device, a translucent window through the panel, a light source for illuminating the translucent window via the rear surface of the panel, and means facilitating installation of the backlit display.

### FIELD OF THE INVENTION

The present invention relates to housings for computers and other data appliances and, in particular, to exploitation of otherwise unused cabinet portions.

### BACKGROUND OF THE INVENTION

Computers and digital equipment such as routers, servers, storage network devices, telecommunication switches and the like—herein referred to generically as “data appliances”—are typically housed in cabinets that stand on their own (e.g., desktop computer cabinets) or which can be stacked in a rack configuration. Because the same data appliance can contain different components depending on the purpose (or the customer) for which it is provisioned, and also to provide for later expansion, appliance chassis are generally built in a standard configuration with room to accommodate more than the standard suite of internal components. As a result, the cabinet in which the appliance is housed will have unused “real estate,” i.e., blank face panels that may be removed when accessories are installed. These panels serve no functional or decorative purpose.

### DESCRIPTION OF THE INVENTION

### Brief Summary of the Invention

Accordingly, in a first aspect, the invention comprises a method of modifying a data-appliance cabinet, in particular a cabinet that accommodates a plurality of accessory (e.g., storage or other) devices which may or may not be present, where the space allocated to each accessory device includes a portion of a front (visible) side of the cabinet. The method comprises the steps of providing a display that includes a panel having front and rear surfaces and dimensions matching a front-side portion of the cabinet allocated to an accessory device, a translucent window through the panel, and a light source for illuminating the translucent window via the rear surface of the panel. In a front-side portion of the cabinet allocated to an absent accessory device (i.e., one not actually present in the cabinet), the backlit display is installed with the panel rear surface within the cabinet and the panel front surface exposed such that, upon activation of the light source within the cabinet, the window is backlit for external viewing.

The translucent window may take the form of a word, message, logo or design, and the light source may be physically affixed to the rear surface of the panel. The display is typically installed by removing a blank panel from the cabinet and replacing it with the display.

In preferred embodiments, the light source comprises a bundle of optical fibers extending along the translucent window. Light entering the optical fibers at ends thereof escapes transversely to illuminate the translucent window. A light source for the fibers may, for example, be connected to an existing power source within the cabinet.

In another aspect, the invention comprises a display for a data-appliance cabinet that accommodates a plurality of accessory devices which may or may not be present, where the space allocated to each accessory device includes a portion of a front side of the cabinet. The display comprises a panel having front and rear surfaces and dimensions matching a front-side portion of the cabinet allocated to an accessory device, a translucent window through the panel, a light source for illuminating the translucent window via the rear surface of the panel, and means facilitating installation of the backlit display. In particular, the display is installed in the front-side portion of the cabinet allocated to an absent accessory device. Activation of the light source within the cabinet causes the window to be backlit for external viewing.

The light source may be physically affixed to the rear surface of the panel, and may include means facilitating connection to an existing power source within the cabinet. As set forth above, the light source may comprise a bundle of optical fibers extending along the translucent window, such that light entering the optical fibers at ends thereof escapes transversely to illuminate the translucent window.

### BRIEF DESCRIPTION OF THE DRAWINGS

The foregoing discussion will be understood more readily from the following detailed description of the invention, when taken in conjunction with the accompanying drawings, in which:

FIG. 1 is a perspective view of a desktop computer incorporating a display in accordance with the invention;

FIG. 2 is an exploded view of the desktop computer shown in FIG. 1, and illustrating installation of the display;

FIGS. 3 and 4 are front and rear perspective views, respectively, of a display in accordance with the invention;

FIGS. 5 and 6 are front and rear elevations, respectively, of a display in accordance with the invention;

FIGS. 7 and 8 are top and bottom view, respectively, of a display in accordance with the invention; and

FIGS. 9 and 10 are left-side and right-side elevations, respectively, of a display in accordance with the invention.

The figures and components shown therein may not be drawn to scale.

### DETAILED DESCRIPTION OF THE PREFERRED EMBODIMENTS

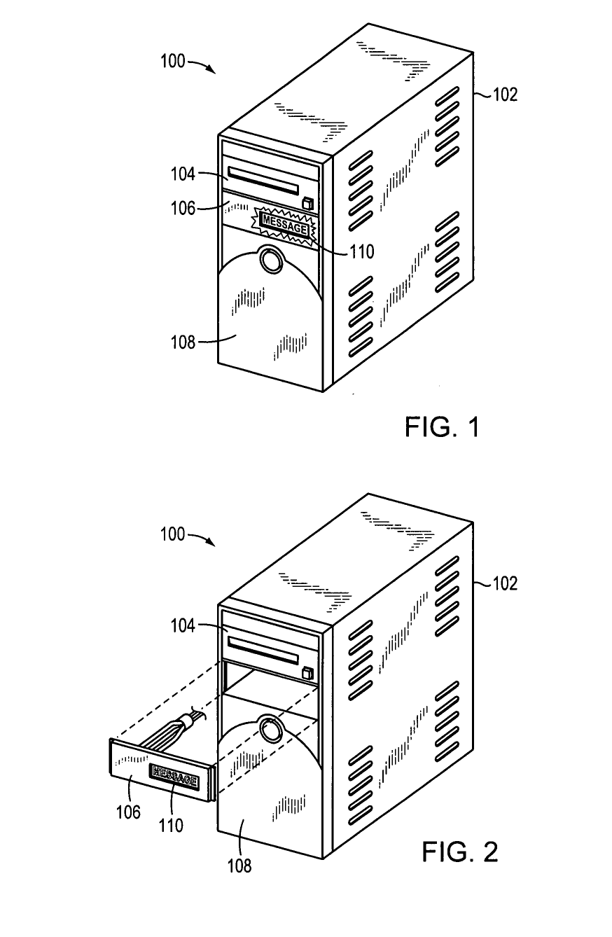

Refer first to FIG. 1, which shows a desktop computer 100 incorporating the invention. The computer 100 is housed within a cabinet 102 and includes a CD-ROM drive 104 and a display panel 106 in accordance with the invention. These are both visible features of (i.e., are substantially flush with the surface of) a front face 108 of the cabinet 102. Display panel 106 includes a backlit display message 110 (which, although generically illustrated as the word MESSAGE, may be a word or words, a message, a logo, a design, or some combination thereof. As shown in FIG. 2, display panel 106 is installed by removing a blank panel from the front face 108 of cabinet 102; the blank panel (not shown) would have overlain an empty accessory compartment within the cabinet 102. If the computer's user decides, in the future, to install an accessory within the empty compartment, the display panel 106 can simply be removed.

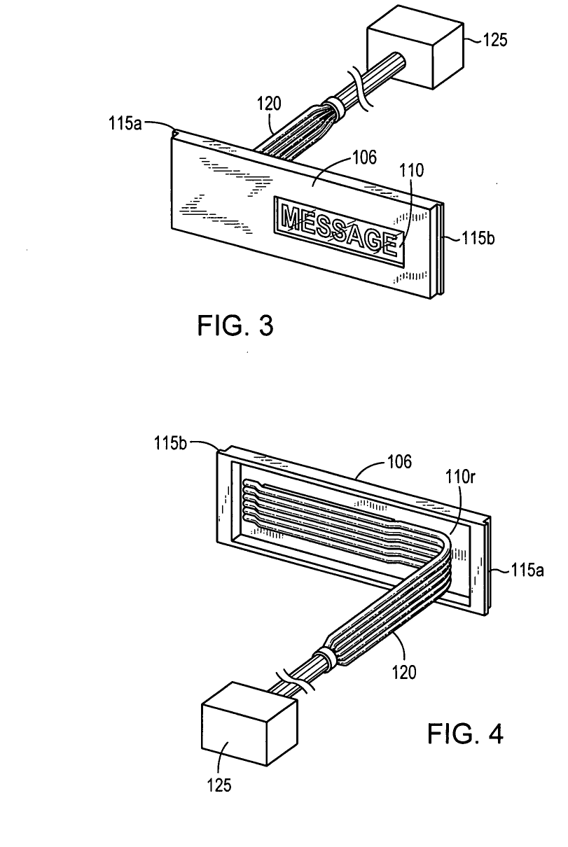

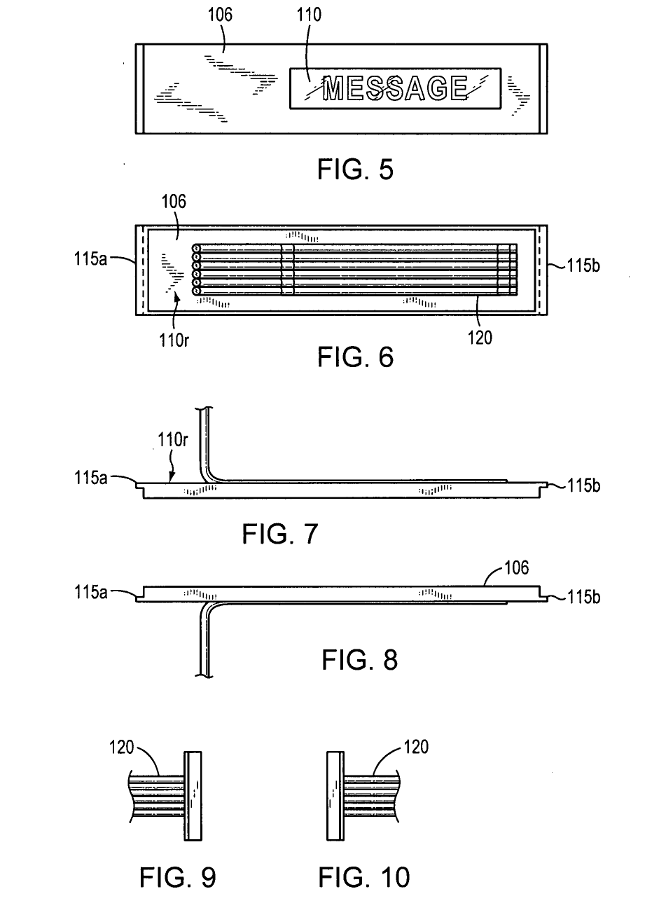

As best seen in FIGS. 3-8, display panel 106 has a pair of tabs or flanges 115a, 115b that are received within complementary detents or recesses (not shown) within the interior surface of cabinet 102. Of course, many alternative means may be used to secure display 106 to cabinet 102, but it is desirable for such means to match, to the extent practicable, those of the blank panel the display 106 will replace.

With reference to FIGS. 3 and 4, the display message 110 comprises a translucent display window. The entire message region 110 is not translucent, however. Rather, only those portions corresponding to the message permit light to pass through. A bundle of optical fibers 120 is arranged flush with (and fully covering, in vertical and horizontal extents) the rear surface 110r of the translucent display window. Light from a light source 125 illuminates the ends of the optical fibers 120, and escapes transversely from the fibers along their extends so as to illuminate the translucent window from the rear. Optical fibers 120 (which are, of course, far thinner than illustrated) may be held against surface 110r using brackets, adhesive, or any other suitable expedient.

Light source 125 is preferably driven using power sources already available in the computer 100 and accessible via the empty accessory compartment behind display 106. For example, light source 125 may terminate in a hard-disk power connector (e.g., a standard four-pin male connector plug) that is connected to the motherboard or a cable within computer 100.

It will therefore be seen that the foregoing represents a highly versatile, self-contained and conveniently implemented approach to dedicating otherwise wasted cabinet space to a display. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A method of modifying a data-appliance cabinet of the type accommodating a plurality of accessory devices in cabinet space allocated thereto whether or not the accessory devices are actually present in the cabinet, the space allocated to each accessory device including a portion of a front side of the cabinet, the method comprising the steps of:
a. providing a display including a (i) a panel having front and rear surfaces and dimensions matching a front-side portion of the cabinet allocated to an accessory device, (ii) a translucent window through the panel, and (iii) a light source for illuminating the translucent window via the rear surface of the panel; and
b. installing, in a front-side portion of the cabinet allocated to an absent accessory device, the backlit display with the panel rear surface within the cabinet and the panel front surface exposed such that, upon activation of the light source within the cabinet, the window is backlit for external viewing.

2. The method of claim 1 wherein the translucent window comprises at least one of a word, message, logo or design.

3. The method of claim 1 wherein the light source is physically affixed to the rear surface of the panel.

4. The method of claim 1 wherein the front-side portion of the cabinet allocated to an absent accessory device comprises a blank panel, and further comprising the step of removing the blank panel and installing the backlit display in lieu thereof.

5. The method of claim 1 further comprising the step of connecting the light source to an existing power source within the cabinet.

6. The method of claim 1 wherein the light source comprises a bundle of optical fibers extending along the translucent window, light entering the optical fibers at ends thereof escaping transversely to illuminate the translucent window.

7. A display for a data-appliance cabinet of the type accommodating a plurality of accessory devices in cabinet space allocated thereto whether or not the accessory devices are actually present in the cabinet, the space allocated to each accessory device including a portion of a front side of the cabinet, the display comprising:
a. a panel having front and rear surfaces and dimensions matching a front-side portion of the cabinet allocated to an accessory device;
b. a translucent window through the panel;
c. a light source for illuminating the translucent window via the rear surface of the panel; and
d. means facilitating installation, in the front-side portion of the cabinet allocated to an absent accessory device, the backlit display with the panel rear surface within the cabinet and the panel front surface exposed, activation of the light source within the cabinet causing the window to be backlit for external viewing.

8. The display of claim 7 wherein the translucent window comprises at least one of a word, message, logo or design.

9. The display of claim 7 wherein the light source is physically affixed to the rear surface of the panel.

10. The display of claim 7 wherein the light source comprises means facilitating connection to an existing power source within the cabinet.

11. The display of claim 7 wherein the light source comprises a bundle of optical fibers extending along the translucent window, light entering the optical fibers at ends thereof escaping transversely to illuminate the translucent window.
